(19) United States
(12) Patent Application Publication
(10) Pub. No.: US 2008/0155597 A1
(43) Pub. Date: Jun. 26, 2008

(54) VEHICLE TV AND CONTENT ROUTER

(76) Inventor: Shlomo Turgeman, Ramat Efal (IL)

Correspondence Address: David Klein;DEKEL PATENT LTD., Beit HaRof'im, 18 Menuha VeNahala Street, Room 27, Rehovot, omitted

(21) Appl. No.: 11/616,034

(22) Filed: Dec. 26, 2006

(51) Int. Cl. G06F 3/00

(52) U.S. Cl. 725/39

(57) ABSTRACT

A router that routes television signals from a cellular communication system to a plurality of receivers in a vehicle.

### FIELD OF THE INVENTION

The present invention relates generally to routers for broadcast communication and the like, and particularly to such a router that routes television signals from a broadcast, cellular or other communication system to a plurality of wired and wireless devices in a vehicle, such as an automobile, train or plane.

### BACKGROUND OF THE INVENTION

Modern cars and other vehicles employ sophisticated communication devices, such as multiple television screens. Other devices such as portable music players and game consoles are also used by passengers in vehicle environments.

Each vehicle-installed and portable device can be used for different broadcast material, such as various television channels, received from terrestrial or satellite broadcast or from cellular telephone networks, picked-up by single or multiple antennas installed on the vehicle. Devices with storage capabilities (such as portable video or music players) may also be used as sources of content via other devices in the vehicle environment.

### SUMMARY OF THE INVENTION

The present invention seeks to provide a novel router that routes content such as television signals broadcast over terrestrial or satellite systems (e.g. DVB-H, DVB-T, DVB-S or ATSC) or available via a cellular communication system, to a plurality of devices in a vehicle, as is described hereinbelow. A router installed in the vehicle may be used to distribute content picked up from external broadcast and content stored on devices located in the vehicle to the appropriate devices, using wired or wireless connections. The router may include a user interface including an electronic program guide (EPG) providing a listing of available content; as well as content management functionality, such as the ability to limit access to some types of content for children seated in the vehicle. This user interface may be accessed from any device connected to the router.

The router may connect to several inputs including terrestrial and satellite television and radio broadcast; cellular telephone; as well as wired and wireless devices located in the vehicle, which possess content storage capabilities, such as portable video players or game consoles. Broadcast reception may be carried out using internal tuners (which are an integral part of the router), or using external tuners connected to the router. The router may receive several content feeds, including free-to-air television channels, encrypted television channels, satellite radio; specialty content such as traffic and weather reports; web content; and personal content such as digital photos stored on a portable device.

The router may have several outputs, including both wired and wireless outputs. The outputs may allow connection of devices installed in the vehicle (e.g., television screens installed in the driver console or the seat head-rests) or portable devices located in the vehicle. Connection types may include digital video connections (e.g. HDMI), wired computer connections (e.g. USB), and wireless connections (e.g. 802.11 wireless network).

Some connections to the router may be dedicated to input or output only, while others may have both input and output capabilities.

Once a device is connected to the router, it can display an electronic program guide (EPG) generated by the router, including all content currently available via the router. This EPG may be generated from data encapsulated in the broadcast signal, data received over cellular networks (e.g. SMS messages), and directory listings of portable devices connected to the router, describing the content stored on these devices. The router may also provide a different EPG to different passengers in the vehicles (e.g. a limited EPG for children).

Once a passenger selects specific content from the EPG, the router will route this content to the specific device used by this passenger. The router may decode content or convert it to a different broadcast format which can be consumed by the specific device as needed. It may also decode content which was encrypted by a conditional access system, using a smart-card or other device provided by the broadcaster to its subscribers.

The router may include digital recording capabilities, allowing passengers to store content for future consumption, or pause playback and resume it later.

### BRIEF DESCRIPTION OF THE DRAWINGS

The present invention will be understood and appreciated more fully from the following detailed description, taken in conjunction with the drawing in which:

FIG. 1 is a simplified pictorial illustration of a vehicle TV router, constructed and operative in accordance with an embodiment of the present invention.

### DETAILED DESCRIPTION OF EMBODIMENTS

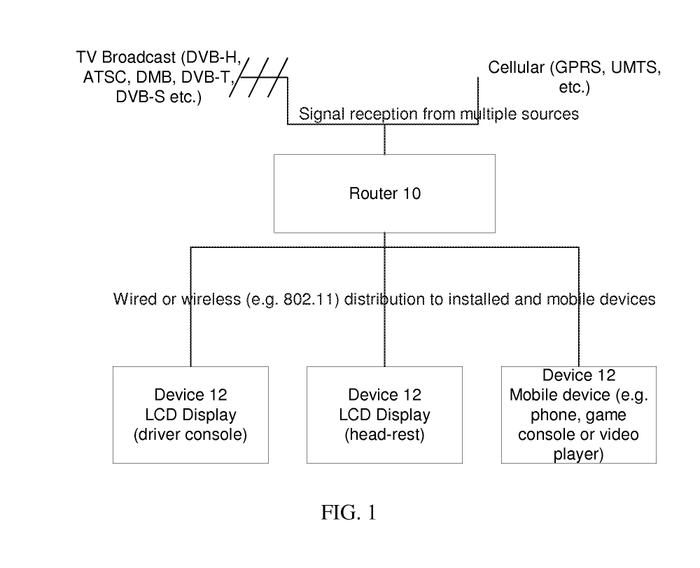

Reference is now made to FIG. 1, which illustrates a vehicle TV router 10, constructed and operative in accordance with an embodiment of the present invention.

Vehicle TV router 10 may include a single or multiple tuners for receiving data signals from a content provider via broadcast (terrestrial and satellite), cellular or other communication systems. Cellular TV router 10 may receive, for example, TV signals from a plurality of television programs broadcast over terrestrial networks P1, P2, . . . Pn; other television programs broadcast over satellite S1, S2, . . . Sn; as well as weather and traffic information broadcast over a cellular network using SMS or MMS messages. Vehicle TV router 10 may route the signals to a plurality of devices 12 disposed in a vehicle 14 (e.g., car, train, plane, boat, etc.). Devices 12 may include TV displays or cellular phones installed in vehicle 14, as well as portable devices such as portable computers, video players and game consoles, connected via cable or wireless connection. Each individual viewer in the vehicle 14 may view different content on his/her own receiver 12.

The scope of the present invention includes both combinations and subcombinations of the features described hereinabove as well as modifications and variations thereof which would occur to a person of skill in the art upon reading the foregoing description and which are not in the prior art.

What is claimed is:

1. A method comprising:
providing a router that routes content comprising television signals, broadcast over a terrestrial TV system, a satellite TV system or a cellular communication system, to a plurality of devices in a vehicle; and
providing a user interface including an electronic program guide (EPG) providing a listing of available content and a content management functionality.

2. The method according to claim 1, wherein said content management functionality comprises limiting access to some types of content for children seated in the vehicle.

3. The method according to claim 1, further comprising receiving the TV signals using internal tuners which are an integral part of the router.

4. The method according to claim 1, further comprising receiving the TV signals using external tuners connected to the router.

5. The method according to claim 1, wherein said content comprises at least one of free-to-air television channels, encrypted television channels, satellite radio, traffic and weather reports; web content; and digital photos.

6. A system comprising:
a router adapted to route content comprising television signals, broadcast over a terrestrial TV system, a satellite TV system or a cellular communication system, to a plurality of devices in a vehicle; and
a user interface including an electronic program guide (EPG) providing a listing of available content and a content management functionality.

7. The system according to claim 6, wherein said content management functionality comprises limiting access to some types of content for children seated in the vehicle.
